(19) United States
(12) Patent Application Publication
(10) Pub. No.: US 2009/0255213 A1
(43) Pub. Date: Oct. 15, 2009

(54) SANDWICH PANEL WITH CLOSED EDGE AND METHODS OF FABRICATING

(75) Inventor: Ulrich SCHWARTAU, Port d Andratx (ES)

Correspondence Address: RENNER OTTO BOISSELLE & SKLAR, LLP, 1621 EUCLID AVENUE, NINETEENTH FLOOR, CLEVELAND, OH, 44115, US

(73) Assignee: INNOVIDA HOLDINGS, INC., Miami, FL (US)

(21) Appl. No.: 12/101,646

(22) Filed: Apr. 11, 2008

(51) Int. Cl. E04C 2/34; B32B 3/26; B29C 65/54; E04C 2/38

(52) U.S. Cl. 52/794.1; 428/188; 428/57; 52/802.1; 156/292; 52/716.8

(57) ABSTRACT

The edge of a construction element, such as a sandwich panel having a core and two outer layers, is closed such that forces acting on the construction element are directed to the outer layers and generally not through the panel core. A portion of the core may be removed to define a cavity within the construction element. A bonding material closes the edge by filling the cavity and forming a new edge that is substantially coplanar to the edges of the outer layers. The edge also can be closed by inserting the edge into a U-profile bracket and connecting the outer layers of the panel to side walls of the U-profile bracket.

### TECHNICAL FIELD OF THE INVENTION

The present invention relates generally to constructing buildings, and more particularly, to closing an edge of a sandwich panel for connecting the sandwich panel to another construction element and distributing forces acting on the panel to outer layers of the panel.

### DESCRIPTION OF THE RELATED ART

There is an increasing demand for lower cost buildings such as houses, warehouses and office space. The demand for lower cost buildings is particularly strong in developing countries where economic resources may be limited and natural resources and raw materials may be scarce. For example, in areas of the Middle East or Africa, conventional building materials such as cement, brick, wood or steel may not be readily available or, if available, may be very expensive. In other areas of the world, poverty may make it too costly for people to build houses or other buildings with conventional materials.

The demand for lower cost housing also is high in areas afflicted by war or natural disasters, such as hurricanes, tornados, floods, and the like. These devastating events often lead to widespread destruction of large numbers of buildings and houses, especially when they occur in densely populated regions. The rebuilding of areas affected by these events can cause substantial strain on the supply chain for raw materials, making them difficult or even impossible to obtain. Furthermore, natural disasters often recur and affect the same areas. If a destroyed building is rebuilt using the same conventional materials, it stands to reason that the building may be destroyed or damaged again during a similar event.

It is generally desirable to increase speed of construction and to minimize construction costs. Prefabricated or preassembled components can streamline production and reduce both the time and the cost of building construction. Prefabricated buildings, however, are made from conventional materials that may be scarce or expensive to obtain. Thus, there exists a need for alternative materials and techniques for constructing buildings that use advanced material technologies to increase the speed of construction and also reduce or lower the ownership costs.

### SUMMARY

The present invention provides an alternative to conventional construction materials and techniques. Buildings, such as houses, commercial buildings, warehouses, or other structures can be constructed by composite sandwich panels, which have an insulative core and one or more outer layers. The buildings can be constructed by connecting several panels together with a bonding material, and usually screws, rivets, nails, etc., are not needed for such connections. Generally, composite sandwich panels offer a greater strength to weight ratio over traditional materials that are used by the building industry. The composite panels are generally as strong as, or stronger than, traditional materials including wood-based and steel-based structural insulation panels, while being lighter in weight. The composite sandwich panels also can be used to produce light-weight buildings, such as floating houses or other light-weight structures. Because they weigh less than traditional building materials, composite sandwich panels are generally less expensive to transport.

Sandwich panels generally are more elastic or flexible than conventional materials such as concrete, steel or brick and, therefore, monolithic buildings made from sandwich panels are more durable than buildings made from conventional materials. For example, sandwich panels also may be non-flammable, waterproof and very strong and durable, and in some cases able to resist hurricane-force winds (up to 300 Kph (kilometers per hour)). The panels also may be resistant to the detrimental effects of algae, fungicides, water, and osmosis. As a result, buildings constructed from sandwich panels are better able to withstanding earthquakes, floods, tornados, hurricanes, fires and other natural disasters than buildings constructed from conventional materials.

Multiple sandwich panels can be connected together, for example, to erect walls, to build a ceiling, or to divide the interior of the building into one or more rooms, etc. As described below, prior to installation, an edge of the panel core is closed by removing a portion of the core and replacing it with a bonding material or by inserting the edge of the panel into a U-shape bracket, also referred to as a U-profile bracket, or otherwise at least partially covering the edge by a U-profile bracket. The closed edge directs loads or forces acting on the sandwich panel towards the outer layers of the panel, which may be stiffer than the panel core, allowing the sandwich panel to be used as either a load bearing or a non-load bearing construction element.

According to one aspect of the invention, a construction element includes two outer layers, each having at least one edge and a core separating the outer layers, the core having at least one edge. The edges of the outer layers extend beyond the edge of the core and a cavity in the construction element partially defined by the outer layers and the core. Bonding material has an edge that is substantially coplanar to the edges of the outer layers.

According to an embodiment of the construction element, cavity extends along a length of each outer layer and the length of the cavity along each outer layer is at least seven times greater than a thickness of one of the outer layers.

According to another embodiment of the construction element, the cavity extends perpendicularly from the outer layers along a length of the core, wherein the length of the cavity extending perpendicularly into the core is at least seven times greater than the thickness of the outer layer.

According to another embodiment of the construction element, the cavity extends between both outer layers.

According to another embodiment of the construction element the core is an insulating material and the outer layers are a composite material.

According to another embodiment of the construction element, the bonding material is glass fiber reinforced epoxy.

According to another embodiment of the construction element, the second construction element connected to the construction element at the closed edge thereof.

According to another embodiment of the construction element, the cavity extends along a length of each outer layer and along a length of the core perpendicular to the outer layers, wherein the lengths are least seven times greater than a thickness of one of the outer layers, and wherein the bonding material is glass fiber reinforced epoxy.

According to another aspect of the invention, a method of closing the edge of a sandwich panel in which the sandwich panel has two outer layers and a core separating the outer layers, the method including removing a portion of the core to form a cavity within the panel, the cavity partially defined by a portion of the outer layers and the core and filling the cavity with a bonding material to form an edge.

According to an embodiment of the method, the removing step includes removing a portion of the core near each of the outer layers, and the portion removed near the outer layers has a length that is at least seven times longer than a thickness of one of the outer layers.

According to another embodiment of the method, the removing step further includes removing a length of the core that extends perpendicularly from the outer layers, wherein the length of the portion removed is at least seven times a thickness of the outer layer.

According to another embodiment of the method, the removing step further includes removing a portion of the core that extends between the outer layers.

According to another embodiment of the method, the outer layers and the core each have an edge and the edges of the outer layers extend beyond the edge of the core when the portion of the portion of the core is removed.

According to another embodiment of the method, the filling step further includes spreading the bonding material to form an edge, the edge of the bonding material being substantially coplanar with the edges of the outer layers.

According to another embodiment of the method, further includes connecting the closed edge of the sandwich panel to a second construction element.

According to another embodiment of the method, the removing step includes removing a portion of the core near each of the outer layers and a portion of the core perpendicular to the outer layers, wherein the portions have a length at least seven times longer than a thickness of one of the outer layers, and wherein the filling step further includes spreading the bonding material to form an edge, the edge of the bonding material being substantially coplanar with the edges of the outer layers.

According to another aspect of the invention, a method of closing the edge of a sandwich panel, wherein the sandwich panel has two outer layers separated from one another by a core, and an edge formed by a portion of the outer layers and the core, the method including partially inserting an edge of the sandwich panel into a U-profile bracket, wherein the U-profile bracket includes two side walls separated by a bottom wall, and connecting the outer layers to the side walls of the U-profile bracket with a bonding material.

According to another embodiment of the method, the edge is in contact with the bottom wall of the U-profile bracket.

According to another embodiment of the method, the edge is spaced from the bottom wall of the U-profile bracket to form a gap.

According to another embodiment, the method includes leaving an open space in the gap between the edge and the bottom wall.

According to another embodiment of the method, the bonding material extends along a length of the outer layers, wherein the length that is at least about seven times longer than a thickness of the outer layers.

According to another embodiment, the method further includes connecting the bottom wall of the U-profile bracket to a second construction element.

According to another embodiment, the edge is spaced from the bottom wall of the U-profile bracket to form a gap that is an open space and the bonding material extends along a length of the outer layers, wherein the length is at least about seven times a thickness of the outer layers.

According to another aspect of the invention, a construction element including a U-profile bracket having a first side wall, a second side wall and a bottom wall separating the side walls, a sandwich panel having first outer layer and a second outer layer and a core separating the outer layers, the outer layers and core having an edge, wherein the U-profile bracket closes the edge of the sandwich panel and the first side wall is connected to the first outer layer with bonding material and the second side wall is connected to the second outer layer with bonding material.

According to an embodiment of the construction element, the bottom wall of the U-profile bracket and the panel edge are spaced from one another to form a gap.

According to another embodiment of the construction element, the bonding material is between the outer layers of the sandwich panel and the side walls of the U-profile bracket, and the bonding material extends along a length of the outer layers, wherein the length that is at least about seven times a thickness of the outer layers.

According to another embodiment, the construction element further includes a second construction element connected to the construction element at the bottom wall of the U-profile bracket.

According to another aspect of the invention, a connection between two construction elements, including a sandwich panel having a closed edge, a construction element having a surface, and bonding material connecting the closed edge of the sandwich panel to the construction element.

According to an embodiment of the connection, the bonding material is between the closed edge of the first sandwich panel and the surface of the second construction element.

According to another embodiment of the connection, the bonding material is at a point of contact between the sandwich panel and the surface of the construction element, and the bonding material had a radius that is at least seven times the thickness of the outer layers.

According to another embodiment of the connection, the construction element is a second sandwich panel and the surface is a closed edge of the second sandwich panel.

According to another embodiment of the connection, the each sandwich panel includes a core having an edge, two outer layers having edges that are separated from one another by the core, and a cavity partially defined by the core and the outer layers, the cavity filled with a bonding material to close the edge of the panel.

According to another embodiment of the connection, the bonding material is substantially coplanar to the edges of the outer layers.

According to another embodiment of the connection, the closed edge directs a force on the panel to an outer layer of the sandwich panel.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

It should be emphasized that the term “comprises/comprising” when used in this specification is taken to specify the presence of stated features, integers, steps or components but does not preclude the presence or addition of one or more other features, integers, steps, components or groups thereof.

Features that are described and/or illustrated with respect to one embodiment may be used in the same way or in a similar way in one or more other embodiments and/or in combination with, or instead of, the features of the other embodiments.

### BRIEF DESCRIPTION OF THE DRAWINGS

FIG. 1 is an environmental view of an exemplary monolithic structure built with composite materials.

FIG. 2 is a fragmentary schematic sectional view of a closed edge sandwich panel extending generally vertically and connected to a construction element.

FIG. 3 is a fragmentary schematic sectional view of a closed edge sandwich panel extending generally vertically and connected to a construction element with a U-profile bracket.

FIG. 4 is a fragmentary schematic sectional view of two vertical closed edge sandwich panels connected together.

FIG. 5 is a fragmentary schematic sectional view of two vertical sandwich panels connected together with U-profile brackets.

FIG. 6 is a sectional view of an exemplary sandwich panel.

FIG. 7 is an isometric view of an exemplary sandwich panel.

FIG. 8A is a fragmentary schematic top sectional view of an edge portion of an exemplary sandwich panel.

FIG. 8B is a fragmentary schematic top sectional view of the edge portion of the sandwich panel of FIG. 8A with a portion of the core removed.

FIG. 8C is a fragmentary schematic top sectional view of the edge portion of the sandwich panel of FIG. 8A with a closed edge.

FIG. 9 is a fragmentary schematic top sectional view of the edge portion of the sandwich panel with U-profile bracket closed edge.

### DETAILED DESCRIPTION OF EMBODIMENTS

In the detailed description that follows, like components have been given the same reference numerals regardless of whether they are shown in different embodiments of the invention. To illustrate the present invention in a clear and concise manner, the drawings may not necessarily be to scale and certain features may be shown in somewhat schematic form. Certain terminology is used herein to describe the different embodiments of the invention. Such terminology is used only for convenience when referring to the figures. For example, “upward,” “downward,” “above,” or “below” merely describe directions in the configurations shown in the figures. The components can be oriented in any direction and the terminology should therefore be interpreted to include such variations.

The structures described herein are built with composite materials, such as sandwich panels. Sandwich panels, which may be formed from synthetic materials, provide a light-weight and potentially less expensive alternative to conventional raw materials, e.g., wood, concrete, metal, etc. Sandwich panels are usually connected or joined together with a high-strength bonding material, such as epoxy or glue, and conventional materials, such as nails and screws, are not usually needed. The result is a strong and durable monolithic (e.g., single unit) structure, as described further below. While described primarily with respect to house construction, it will be appreciated that all of the concepts described herein are equally applicable to the construction of any type building, such as warehouses, commercial buildings, factories, apartments, etc.

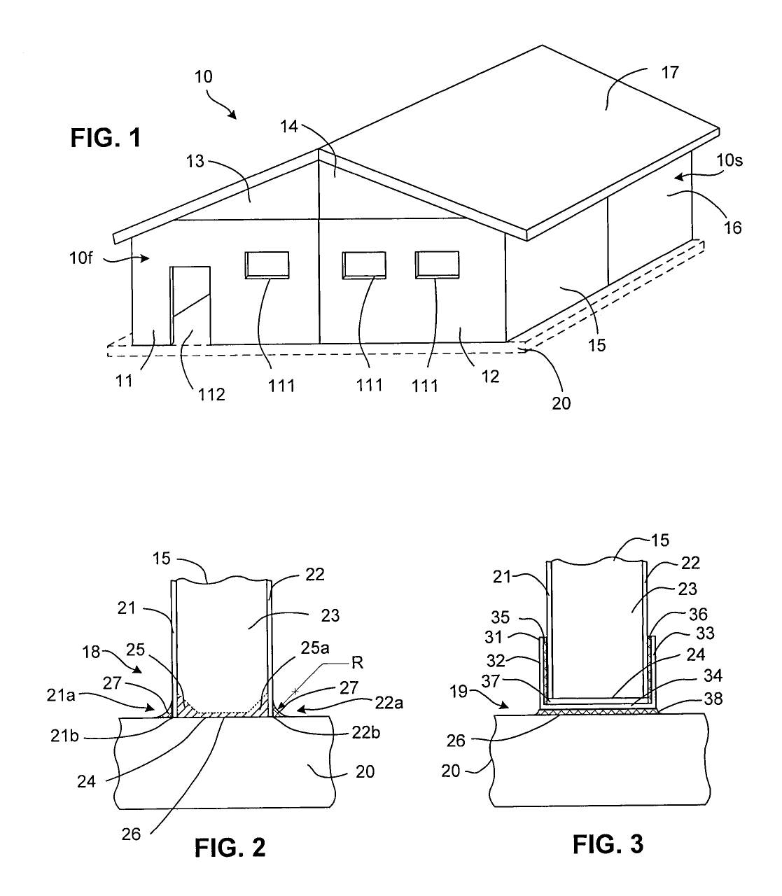

Referring to FIG. 1, an exemplary monolithic structure 10, such as a house, is built from several sandwich panels, which are connected together. The house 10 includes of a front wall 10f formed from sandwich panels 11, 12, 13, 14, a side wall 10s formed from sandwich panels 15, 16, and a roof 17. Connections 18, 19 (see FIGS. 2 and 3) may be provided between respective walls and/or with a base 20. For example, the front and side walls are connected to a base 20, or a foundation member. Although not shown in FIG. 1, it will be appreciated that the house 10 also includes another side wall and a rear wall.

FIGS. 2 and 3 illustrate several exemplary embodiments of the invention in which connections 18, 19 are made between a sandwich panel, for instance sandwich panel 15, and another construction element, e.g., the base 20, for example, a floor, foundation, etc. of the house 10, or another sandwich panel. The sandwich panel 15 includes two outer layers 21, 22 having edges 21a, 22a and a core 23 having an edge 24. As is described in more detail below, exemplary core 23 material of a sandwich panel 15 may be a foam material, and the outer layers 21, 22 may be made of a laminate that usually is stiffer, harder, and stronger than the core material. As also is described in more detail below, the edge 24 of a sandwich panel 15 is appropriately prepared, e.g., closed, and may be attached to another object or structure such as, for example, the base 20, to another sandwich panel, etc.

As is illustrated in FIG. 2, the edge 24 of the sandwich panel is closed by removing a portion 25 of the core 23 and replacing it with a bonding material 25a. The closed edge 24 is placed into physical contact with a surface 26 of the base 20, forming two corners 21a, 22a between the exposed edges 21b, 22b of the outer layers 21, 22 and the base 20. The corners are filled or sealed with bonding material 27 to connect the sandwich panel 15 to the base 20.

The bonding material 27 is shaped into a rounded corner to form a radius R. The length of the radius R may be selected based upon the thicknesses of the outer layers 21, 22 according to a desired ratio. The desired ratio of the radius R to the thickness of the outer layers 21, 22 may be about seven to one (7:1), or more, e.g., 8:1 or an even larger ratio. For instance if the outer layers 21, 22 are about 2 mm (millimeters) thick, the radius R would be at least approximately 14 mm (millimeters), and may be thicker, if desired, or adjusted based upon a desired strength or other factor. In another example, the outer layers 21, 22 may be 3 mm (millimeters) thick, the radius R would be at least approximately 21 mm (millimeters) or more. Additional bonding material may be applied between the closed edge 24 and the surface 26 of the base 20, as may be desired. The combination of the closed edge 24 and the radius of bonding material 27 transfers or directs the forces acting on the panel 15 generally in the direction of the outer layers 21, 22 and/or the surface 26 of the base 20. Due to the strength of the outer layers, 21, 22, the panel 15 may be used as either a load bearing or a non-load bearing construction element.

In FIG. 3, another embodiment of a connection 19 between the sandwich panel 15 and the base 20 is depicted in FIG. 3. A U-shape bracket 31, also referred to as a U-profile bracket, is shown closing the edge 24 of the sandwich core 23 and connecting the sandwich panel 15 to the outer layer 26 of the base 20. The U-profile bracket 31 has two side walls 32, 33 connected by a bottom wall 34 to form the general shape of a “U”. The U-profile bracket 31 is bonded to the outer layers 21, 22 by bonding material 35, 36 between the side walls 31, 32 and the outer layers 21, 22. The U-profile bracket also may or may not have end walls.

A gap 37 may be created between the edge 24 of the core 23 and the bottom wall 34 of the U-profile bracket 31. The gap 37 may be filled with bonding material or may be substantially free of bonding material. It will be appreciated that while a gap 37 is shown in FIG. 3, the edge 24 of the panel may be in contact with the bottom wall 34 of the U-profile bracket 31, e.g., the gap 37 may be 0 mm (millimeters) wide. Alternatively, the gap 37 may be several millimeters or more in width.

The bottom wall 43 of the U-profile bracket 31 is connected to the base 20 by bonding material 38. The bonding material 38 connects the sandwich panel 15 to the construction element 20 facilitates the transmission of forces acting on the sandwich panel 15 to the outer layers 21, 22 and generally not through the core 23. The forces transferred between the sandwich panel 15 and the base 20 also are directed through the U-profile bracket 31 and the bonding material 38 to the surface 26 of the base 20. The panel 15 can be used either as a load bearing element or a non-load bearing construction element.

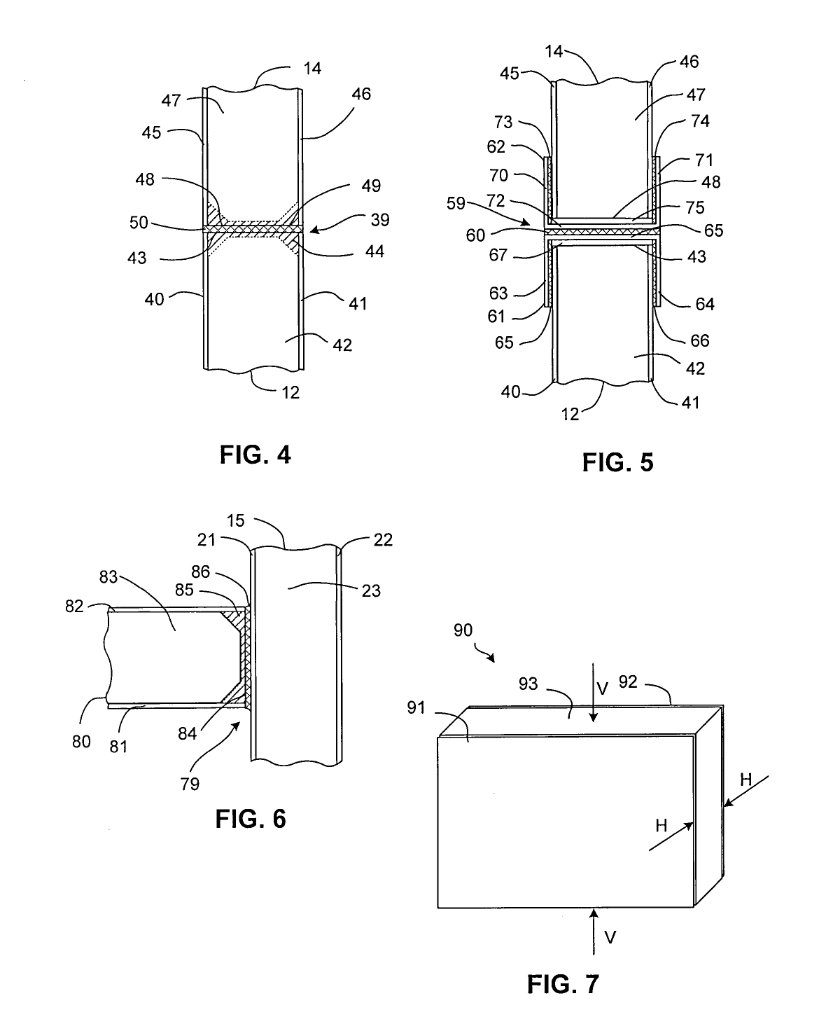

FIG. 4 illustrates an exemplary connection 39 between a sandwich panel, for instance sandwich panel 12, and another construction element, e.g., sandwich panel 14. The sandwich panels 12, 14 generally are coplanar or coextensive with one another when connected as shown in FIG. 4 and connected edge to edge. Sandwich panel 12 includes two outer layers 40, 41 separated from one another by a core 42. The edge 43 of the sandwich panel 12 is closed by removing a portion 44 of the core 42 and replacing it with a bonding material. Similarly, sandwich panel 14 has two outer layers 45, 46 that are separated by a core 47, and a closed edge 48, formed by removing a portion 49 of the core 47 and replacing it with bonding material. The closed edges 43, 48 of the sandwich panels are connected to one another with bonding material 50, and any forces acting between the two sandwich panels are directed towards the outer layers of the sandwich panels and generally not through the panel cores.

Referring to FIG. 5, another exemplary connection 59 between sandwich panels 12, 14 is shown. The sandwich panels 12, 14 are connected to one another by bonding material 60 between two U-profile brackets 61, 62. The edge 43 of sandwich panel 12 is closed by U-profile bracket 61. The U-profile bracket 61 has two side walls 63, 64 connected by a bottom wall 65. The U-profile bracket 61 is bonded to the outer layers 40, 41 by bonding material 65, 66, such that a gap 67 may be created between the edge 43 of the core 42 and the bottom wall 65 of the U-profile bracket 61, however, it will be appreciated that the edge 43 of the panel 14 may be in contact with the bottom wall 65 of the U-profile bracket 61. The edge 48 of sandwich panel 14 is closed in a similar manner with the U-profile bracket 62. The U-profile bracket 62 includes two side walls 70, 71 connected to one another by a bottom wall 72. The side walls 70, 71 are connected to the outer layers 45, 46 by bonding material 73, 74, such that a gap 75 may be formed between the edge 48 and the bottom wall 72, however, it will be appreciated that the edge 48 of the panel 14 may be in contact with the bottom wall 72 of the U-profile bracket 62. As described above, the gaps 67, 75 and the bonding material 65, 66, 73, 74 between the outer walls 40, 41, 45, 46 of the sandwich panels 12, 14 and the side walls 63, 64, 70, 71 of the U-profile brackets 61, 62 generally transfer or direct the forces in the panels to the outer layers of the panels and generally not to the panel cores.

Another exemplary connection 79 of a sandwich panel to a construction element is illustrated in FIG. 6. In FIG. 6, sandwich panel 15 is connected to a horizontal sandwich panel 80, which may be a ceiling element, roof element, floor element, etc. The sandwich panel 80 includes two outer walls 81, 82 and a core 83. As described in more detail below, an edge 84 of the sandwich panel 80 is closed by removing a portion 85 of the core 83 and replacing it with bonding material. The edge 84 is connected to the outer layer 21 of the sandwich panel 15 by bonding material 86. Similar to the configuration of FIGS. 2 and 3, the forces transferred between the sandwich panel 80 and the sandwich panel 15 are directed to the outer layers 81, 82 of the sandwich panel 80 and the outer layer 21 of sandwich panel 15.

Referring briefly to FIG. 7, an exemplary sandwich panel 90 is shown. The sandwich panel 90 includes two outer layers 91, 92 separated by a core 93. The outer layers 91, 92 are bonded or adhered to the core 93 with bonding material.

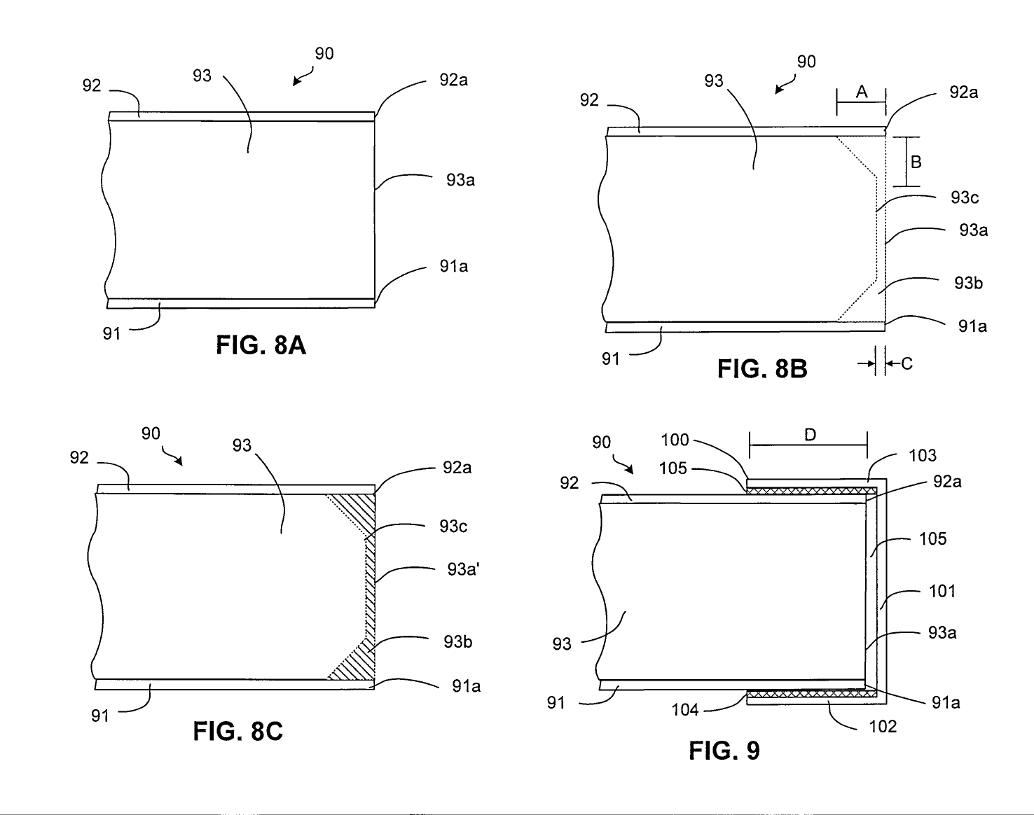

The methods of closing the edges of the sandwich panels are described in more detail in FIGS. 8A-8C and FIG. 9.

FIG. 8A depicts a top view of an edge portion of the sandwich panel 90. As shown in FIG. 8A, an edge 93a of the panel core 93 is generally flush with, even with, or coplanar to edges 91a, 92a of the outer layers 91, 92. The edge 93a of the panel core 93 is exposed or open and may be subject to compression forces or damage if the panel is connected to another construction element. The panel edge, therefore, is closed to protect the core from damage and to distribute the forces acting on the panel in the general direction of the outer layers. It will be appreciated that while the illustrated embodiment has a generally straight edge, the edge may be jagged or shaped, for example as an “S”, or another shape.

The method of closing of the edge of the sandwich panel is illustrated in more detail in FIGS. 8B and 8C. With initial reference to FIG. 8B, a portion 93a of the panel core 93 is removed from the edge 93a of the panel 90. The portion 93b removed creates a cavity or void in the panel core 93 that is partially defined by the outer layers 91, 92 and the remaining portion of the panel core 93.

The portion 93b removed from the core 93 extends along the outer layers 91, 92 from the outer layer edges 91a, 92a, as designated generally by the dimension “A” in FIG. 8B. The portion 93b removed from the core 93 also extends in a generally perpendicular direction from the outer layers 91, 92 and toward the center of the core 93, as designated generally by the dimension “B” in FIG. 8B.

The dimensions A, B of the portion 93b removed from the core 93 are several millimeters in length, and may, for example be approximately 5-25 mm (millimeters) long or more. The length of dimensions A, B may be selected based upon the thicknesses of the outer layers 91, 92 according to a desired ratio. The desired ratio of the dimensions A, B to the thickness of the outer layers 91, 92 may be about seven to one (7:1), or more, e.g., 8:1 or an even larger ratio. For instance if the outer layers 91, 92 are about 2 mm (millimeters) thick, the dimensions A, B would be at least approximately 14 mm (millimeters), and may be thicker, if desired, or adjusted based upon a desired strength or other factor. In another example, if the outer layers 91, 92 may be 3 mm (millimeters) thick and the dimensions A, B would be at least approximately 21 mm (millimeters) or more.

The portion 93b removed from the core 93 extends along the width of the panel 90 between the outer layers 91, 92. The remaining portion of the core 93 forms a new edge 93c. The new edge 93c of the panel core 93, therefore, is recessed from the edges 91a, 92a of the outer layers 91, 92, as indicated by dimension “C” in FIG. 8B. The edges 91a, 92a of the outer layers 91, 92 are not cut or removed from the panel, and therefore, the edges 91a, 92a overhang or extend beyond the new edge 93c of the panel core 93 by dimension C.

The length of dimension C may be any desired length and may, for example, be selected based upon the strength of the bonding material. The length of dimension C may be based on a desired ratio. The desired ratio of the dimension C to the thickness of the outer layers 91, 92 may be about two to one (2:1), or more, e.g., 3:1 or an even larger ratio. The length of dimension C may be approximately the same as the thickness of the outer layers 91, 92. For instance, if the outer layers 91, 92 are approximately 2-3 mm (millimeters) thick, then the new edge 93c of the core 93 may be recessed approximately 2-3 mm (millimeters). It will be appreciated, however, the dimension C and, therefore, the amount that the new edge 93c is recessed may be any desired length, and may, for example, be greater or less than the thickness of the outer layers 91, 92. More core material may be removed for larger (e.g., thicker) outer layers or less core material may be removed for smaller (e.g., thinner) outer layers. It will be appreciated that the core 93 and outer layers 91, 92 may be formed in the configuration of FIG. 8B prior to adhering the outer layers 91, 92 to the core 93, or the sandwich panel may be molded to the desired shape.

The removal of the portion 93b from the core 93 may leave excess or loose material in the cavity, e.g., power or remnants from cutting or removing the portion 93b of the core 93 that inhibit the effect of the bonding material that is used to close the edge. Any of a number of techniques can be used to remove the excess material from the cavity. For example, the remnants can be blown out of the cavity by blowing air into the cavity and across the new edge 93c. The air may be supplied from a high pressure air source or blowing mechanism. Other mechanisms may be used to remove the excess material from the cavity as will be appreciated by one of skill, for example, a vacuum or other device may be used.

Referring now to FIG. 8C, the cavity formed by the removal of the portion 93b from the core 93 is filled with bonding material. The bonding material is spread to form an edge 93a′ that generally is coplanar with the edges 91a, 92a of the outer layers. The bonding material may be any suitable bonding material such as epoxy, epoxy resin, glue, cement, adhesive, adhering material or another bonding material (these terms may be used interchangeably and equivalently herein). The bonding material may be a glass fiber reinforced epoxy and may have the same general thermal expansion characteristics as the materials used to construct the sandwich panel. The bonding material may include filling components, such as, fiberglass or a fiberglass and resin mixture, and may be, for example, microfiber and Aerosil®.

The bonding material 93b solidifies or cures to close the edge of the panel, resulting in a new edge 93a′ that is generally flush with, even with, or substantially coplanar to the edges 91a, 92a of the outer layers 91, 92. The edge of the panel, therefore, is reinforced with the bonding material and the forces acting on the panel are directed towards the outer layers 91, 92 and generally not through the panel core 93, which may not have the same strength, e.g., stiffness or rigidity to support a load on the panel, as the outer layers.

Referring to FIG. 9, the edge 93a of the sandwich panel 90 also may be closed with a U-profile bracket 100. The U-profile bracket 100 has a bottom wall 101 and two side walls 102, 103 and connected to form the general shape of a “U.” The edge 93a of the sandwich panel 90 is insertable into the U-profile bracket 100 as depicted in FIG. 9. The side walls 102, 103 may be spaced slightly wider than the width of the sandwich panel 90 to accommodate insertion of the panel 90 and to provide a gap into which bonding material may be applied. For instance, the space, or gap between the outer layers 91, 92 and the side walls 101, 102 may be about 1-3 mm (millimeters) wide. The walls 102, 103 may be spaced nearer or farther from each other for wider or narrower sandwich panels, and/or based upon a desired tolerance. For instance, if the sandwich panel 90 is about 62 mm (millimeters) wide, the side walls 102, 103 may be spaced about 64 mm (millimeters) to 68 mm (millimeters) apart, or more.

The U-profile bracket 100 may be formed from composite materials, for example, the composite materials used to construct the outer layers 91, 92, as described below. The walls 101, 102, 103 of the U-profile bracket 100 also may be relatively thin with respect to the panel 90, and may, for example be the same thickness as the outer layers 91, 92, or may be approximately two or three times thicker than the outer layers 91, 92 of the panel 90. For instance, the walls 101, 102, 103 may be several millimeters thick and may, for example, be between approximately 1 mm (millimeter)-12 mm (millimeters) thick, however, it will be appreciated that the outer layers can be thinner than 1 mm (millimeter) or thicker than 12 mm (millimeters) as may be desired.

To close the edge of the sandwich panel 90, the edge 93a of the core 93 and the edges 91a, 92a of the outer layers 91, 92 (e.g., a first outer layer 91 and a second outer layer 92) are inserted into the open end of the U-profile bracket 100. Bonding material 104, 105 is applied, injected or otherwise placed into the gap between the outer layers 91, 92 and the respective side walls 102, 103 (e.g., a first side wall 102 and a second sidewall 103) of the U-profile bracket 100. The bonding material adheres or connects the U-profile bracket 100 to the sandwich panel 90 and closes the edge 93a of the panel 90 and also facilitates the transfer of the forces through the U-profile bracket 100 and to the outer layers 91, 92 when the sandwich panel is connected to another construction element. The U-profile bracket 100 extends along the length of the sandwich panel and, therefore, closes the entire edge 93a of the panel. The U-profile bracket also may have end walls.

The side walls 102, 103 extend along a length of the outer layers 91, 92 as indicated generally by dimension “D.” The length of dimension D may be based on a desired ratio. The desired ratio of the dimension D to the thickness of the outer layers 91, 92 may be about seven to one (7:1), or more, e.g., 8:1 or an even larger ratio. The length of the side walls may be about 7 mm (millimeters) to 50 mm (millimeters) or more and may compensate for unevenness in the ground or base 20, or unevenness in the sandwich panels (e.g., the sandwich panels 11-15 of FIG. 1, etc.).

The edge 93a of the panel 90 may be spaced from the bottom wall 101 of the U-profile bracket 100 to form a gap 105. The width of the gap 105 may be about the same as the thickness of the outer layers 91, 92 of the sandwich panel 90, and may, for example, be about 1-3 mm (millimeters). It will be appreciated that a larger or smaller gap 105 may be selected based upon the size of the sandwich panel 90 and/or the size of the U-profile bracket 100 or other criteria. As indicated above, the gap 105 may be zero, e.g., the edge 93a may be in contact with the bottom wall 101 and may be substantially free from bonding material.

As shown in FIG. 9, the gap 105 is generally free from bonding material and the edge 93a and the bottom wall 101 are spaced from one another, which facilitates the transfer of the forces acting on the panel 90 to the outer layers 91, 92 and not through the panel core. The bottom wall 101 also provides a surface for connecting the sandwich panel 90 to another construction element, e.g., another construction element as described above.

It will be appreciated that each edge of the sandwich panel may be closed in the same manner described above, e.g., by removing a portion of the panel core and filling the resulting cavity with a boding material or by a U-profile bracket at each edge. For instance, if the sandwich panel is rectangular, all four edges of the panel can be closed as described above.

Referring back to FIGS. 2 and 3, although generally described with respect to the connection of a sandwich panel to the base, it will be appreciated that other configurations or attachments between the sandwich panel and another construction element are contemplated. For example, the sandwich panel 15 and the construction element 20 may be vertical elements, e.g., another vertical wall in the structure, and FIGS. 2 and 3 may represent the union between the two vertical walls. Alternatively, the sandwich panel may be a vertical wall and the construction element may be a horizontal element, e.g., a ceiling element, a floor element, or a roof element, etc. Alternatively, the construction element 20 may be a vertical wall and the sandwich panel 15 may be a horizontal element, e.g., a ceiling element, a floor element, or a roof element, etc. Furthermore, while the construction element 20 illustrated in FIGS. 2 and 3 is a solid element, it will be appreciated that it may be a sandwich panel 15, as shown in FIG. 6.

Referring to FIGS. 4 and 5, although the sandwich panels have been described as a vertical walls or wall extensions, it will be appreciated that other orientations are possible, For example, the construction elements 12, 14 may be oriented in the horizontal direction to form the base, a ceiling element, a floor element, a roof element, etc. It also will be appreciated that while the two construction elements 12, 14 are illustrated as two sandwich panels, either may be a solid construction element. For example, the construction element 12 may be a solid element and the construction element 14 may be a sandwich panel, e.g., a wall extension, as shown in FIG. 1.

As described above with respect to FIGS. 3-6, the bonding material (e.g., 38, 50, 60, 86) connecting the respective construction elements together may be a layer that is approximately 1-5 mm (millimeters) thick, or more. It will be appreciated, however, that thicker or thinner amounts bonding material may be selected as desirable. The bonding material used to connect the sandwich panels together may be more flexible than the sandwich panels, and may, for example, be four or five times more flexible than the panels. The flexibility of the bonding material, therefore, reduces the likelihood than the panels of the monolithic structure will break or split apart, and also transfers loads from one panel to another and towards the outer layers each respective panel.

It also will be appreciated that while FIG. 5 depicts two separate U-profile brackets 61, 62 connecting the construction elements 12, 14, the U-profile brackets 61, 62 may be combined to form a single bracket in the form of an “H.” In such an embodiment, the construction elements 12, 14 may be connected to one another without the bonding material 60 between the two U-profile brackets 61, 62.

Referring back to FIG. 1, the sandwich panels, for example, sandwich panels 11, 12, may be prefabricated and prepared for installation by cutting the panels to create openings 111, 112 for installing windows, doors, and the like. The sandwich panels typically are manufactured in a rectangular shape, but it will be appreciated that the panels may be manufactured in alternative shapes, as may be desired. While a solid rectangular panel is suitable for solid walls (e.g., the wall formed from the connection of sandwich panels 15, 16 in FIG. 1), further processing is necessary if windows 110, doors 111, or other elements are desired. This further processing may be performed at a manufacturing facility or at a construction site.

The sandwich panel 11 may be customized by cutting and removing a portion of the panel 11 to form an opening for a window 111. The window opening 111 may be cut to any desired size to accommodate the installation of any size window. Similarly, a portion of the panel 11 can be cut and removed to form an opening or doorway 112. Also, a top portion of panel 11 may be removed for installation of an angled eave portion of the roof 17. Although the sandwich panels 11, 12 are shown with window 111 and/or door 112 opening, it will be appreciated that the panel can be customized in any manner desired to meet the specifications of an architectural or design plan. For example, as shown in FIG. 1, the panel 12 includes several window openings 111 and no door opening, while panels 15, 16 are solid walls. The sandwich panels also may be cut in other designs to accommodate other roof, wall, etc., arrangements. It also will be appreciated that while the windows, door and roof are described as being cut from a solid sandwich panel, the openings may be molded or otherwise formed in the panel.

Referring back to FIG. 7, the core 93 of the exemplary sandwich panel 90 may be formed from a light-weight, insulative material, for example, polyurethane, expanded polystyrene, polystyrene hard foam, Styrofoam® material, phenol foam, a natural foam, for example, foams made from cellulose materials, such as a cellulosic corn-based foam, or a combination of several different materials. Other exemplary core materials include honeycomb that can be made of polypropylene, non-flammable impregnated paper or other composite materials. It will be appreciated that these materials insulate the interior of the structure and also reduce the sound or noise transmitted through the panels. The core may be any desired thickness and may be, for example, 30 mm (millimeters)-100 mm (millimeters) thick, however, it will be appreciated that the core can be thinner than 30 mm (millimeters) or thicker than 100 mm (millimeters) as may be desired. In one embodiment, the core is about 60 mm (millimeters) thick.

The outer layers 91, 92 of the sandwich panel, e.g., sandwich panel 90 of FIG. 7, are made from a composite material that includes a matrix material and a filler or reinforcement material. Exemplary matrix materials include a resin or mixture of resins, e.g., epoxy resin, polyester resin, vinyl ester resin, natural (or non oil-based) resin or phenolic resin, etc. Exemplary filler or reinforcement materials include fiberglass, glass fabric, carbon fiber, or aramid fiber, etc. Other filler or reinforcement materials include, for example, one or more natural fibers, such as, jute, coco, hemp, or elephant grass, balsa wood, or bamboo.

The outer layers 91, 92 (also referred to as laminate) may be relatively thin with respect to the panel core 93. The outer layers 91, 92 may be several millimeters thick and may, for example, be between approximately 1 mm (millimeter)-12 mm (millimeters) thick, however, it will be appreciated that the outer layers can be thinner than 1 mm (millimeter) or thicker than 12 mm (millimeters) as may be desired. In one embodiment, the outer layers are approximately 1-3 mm (millimeter) thick.

It will be appreciated that the outer layers 91, 92 may be made thicker by layering several layers of reinforcement material on top of one another. The thickness of the reinforcement material also may be varied to obtain thicker outer layers 91, 92 with a single layer of reinforcement material. Further, different reinforcement materials may be thicker than others and may be selected based upon the desired thickness of the outer layers.

The outer layers 91, 92 are adhered to the core 93 with the matrix materials, such as the resin mixture. Once cured, the outer layers 91, 92 of the sandwich panel 90 are firmly adhered to both sides of the panel core 93, forming a rigid building element. It will be appreciated that the resin mixture also may include additional agents, such as, for example, flame retardants, mold suppressants, curing agents, hardeners, etc. Coatings may be applied to the outer layers 91, 92, such as, for example, finish coats, paint, etc.

The core 93 may provide good thermal insulation properties and structural properties. The outer layers 91, 92 may add to those properties of the core and also may protect the core 93 from damage. The outer layers 91, 92 also provide rigidity and support to the sandwich panel.

The sandwich panels may be any shape. In one embodiment, the sandwich panels are rectangular in shape and may be several meters, or more, in height and width. The sandwich panels also may be other shapes and sizes. The combination of the core 93 and outer layers 91, 92 create sandwich panels with high ultimate strength, which is the maximum stress the panels can withstand, and high tensile strength, which is the maximum amount of tensile stress that the panels can withstand before failure. The compressive strength of the panels is such that the panels may be used as both load bearing and non-load bearing walls. In one embodiment, the panels have a load capacity of at least 50 tons per square meter in the vertical direction (indicated by arrows V in FIG. 7) and 2 tons per square meter in the horizontal direction (indicated by arrows H in FIG. 7). The sandwich panels may have other strength characteristics as will be appreciated in the art.

Internal stiffeners may be integrated into the panel core 93 to increase the overall stiffness of the sandwich panel 90. In one embodiment, the stiffeners are made from materials having the same thermal expansion properties as the materials used to construct the panel, such that the stiffeners expand and contract with the rest of the panel when the panel is heated or cooled.

The stiffeners may be made from the same material used to construct the outer layers of the panel. The stiffeners may be made from composite materials and may be placed perpendicular to the top and bottom of the panels and spaced, for example, at distances of 15 cm (centimeters), 25 cm, 50 cm, or 100 cm. Alternatively, the stiffeners may be placed at different angles, such as a 45-degree angle with respect to the top and bottom of the panel, or at another angle, as may be desired.

Although the invention has been shown and described with respect to a certain preferred embodiment or embodiments, it is obvious that equivalent alterations and modifications will occur to others skilled in the art upon the reading and understanding of this specification and the annexed drawings.

What is claimed is:

1. A construction element comprising:
two outer layers, each having at least one edge;
a core separating the outer layers, the core having at least one edge, wherein the edges of the outer layers extend beyond the edge of the core;
a cavity in the construction element partially defined by the outer layers and the core; and
bonding material in the cavity, the bonding material having an edge that is substantially coplanar to the edges of the outer layers.

2. The construction element of claim 1, wherein the cavity extends along a length of each outer layer, wherein the length of the cavity along each outer layer is at least seven times greater than a thickness of one of the outer layers.

3. The construction element of claim 2, wherein the cavity extends perpendicularly from the outer layers along a length of the core, wherein the length of the cavity extending perpendicularly into the core is at least seven times greater than the thickness of the outer layer.

4. The construction element of claim 2, wherein the cavity extends between both outer layers.

5. The construction element of claim 1, wherein the core is comprised of an insulating material and the outer layers are comprised of a composite material.

6. The construction element of claim 1, wherein the bonding material is comprised of glass fiber reinforced epoxy.

7. The construction element of claim 1, further comprising a second construction element connected to the construction element at the closed edge thereof.

8. The construction element of claim 1, wherein the cavity extends along a length of each outer layer and along a length of the core perpendicular to the outer layers, wherein the lengths are least seven times greater than a thickness of one of the outer layers, and wherein the bonding material is comprised of glass fiber reinforced epoxy.

9. A method of closing the edge of a sandwich panel, wherein the sandwich panel has two outer layers and a core separating the outer layers, the method comprising:
removing a portion of the core to form a cavity within the panel, the cavity partially defined by a portion of the outer layers and the core, and
filling the cavity with a bonding material to form an edge.

10. The method of claim 9, wherein the removing step comprises removing a portion of the core near each of the outer layers, wherein the portion removed near the outer layers has a length that is at least seven times a thickness of one of the outer layers.

11. The method of claim 10, wherein the removing step further comprises removing a length of the core that extends perpendicularly from the outer layers, wherein the length of the portion removed is at least seven times a thickness of the outer layer.

12. The method of claim 9, wherein the removing step further comprises removing a portion of the core that extends between the outer layers.

13. The method of claim 9, wherein the outer layers and the core each have an edge and the edges of the outer layers extend beyond the edge of the core when the portion of the portion of the core is removed.

14. The method of claim 9, wherein the filling step further comprises spreading the bonding material to form an edge, the edge of the bonding material being substantially coplanar with the edges of the outer layers.

15. The method of claim 9, further comprising connecting the closed edge of the sandwich panel to a second construction element.

16. The method of claim 9, wherein the removing step comprises removing a portion of the core near each of the outer layers and a portion of the core perpendicular to the outer layers, wherein the portions have a length at least seven times a thickness of one of the outer layers, and wherein the filling step further comprises spreading the bonding material to form an edge, the edge of the bonding material being substantially coplanar with the edges of the outer layers.

17. A method of closing the edge of a sandwich panel, the sandwich panel comprising two outer layers separated from one another by a core, a portion of the outer layers and the core forming an edge of the panel, the method comprising:
partially inserting the edge of the sandwich panel into a U-profile bracket, wherein the U-profile bracket is comprised of two side walls separated by a bottom wall; and
connecting the outer layers to the side walls of the U-profile bracket with a bonding material.

18. The method of claim 17, wherein the edge is in contact with the bottom wall of the U-profile bracket.

19. The method of claim 17, wherein the edge is spaced from the bottom wall of the U-profile bracket to form a gap.

20. The method of claim 17, comprising leaving an open space in the gap between the edge and the bottom wall.

21. The method of claim 17, wherein the bonding material extends along a length of the outer layers, wherein the length that is at least about seven times a thickness of the outer layers.

22. The method of claim 17, further comprising connecting the bottom wall of the U-profile bracket to a second construction element.

23. The method of claim 17, wherein the edge is spaced from the bottom wall of the U-profile bracket to form a gap that is an open space and the bonding material extends along a length of the outer layers, wherein the length is at least about seven times a thickness of the outer layers.

24. A construction element comprising:
a U-profile bracket having a first side wall, a second side wall and a bottom wall separating the side walls,
a sandwich panel having first outer layer and a second outer layer and a core separating the outer layers, the outer layers and core having an edge, wherein the U-profile bracket closes the edge of the sandwich panel and the first side wall is connected to the first outer layer with bonding material and the second side wall is connected to the second outer layer with bonding material.

25. The construction element of claim 24, wherein the bottom wall of the U-profile bracket and the panel edge are spaced from one another to form a gap.

26. The construction element of claim 25, wherein the bonding material between the outer layers of the sandwich panel and the side walls of the U-profile bracket extends along a length of the outer layers, wherein the length is approximately seven times a thickness of the outer layers.

27. The construction element of claim 24, further comprising a second construction element connected to the construction element at the bottom wall of the U-profile bracket.

28. A connection between two construction elements, comprising:
a sandwich panel having a closed edge;
a construction element having a surface; and
bonding material connecting the closed edge of the sandwich panel to the construction element.

29. The connection of claim 28, wherein the bonding material is between the closed edge of the first sandwich panel and the surface of the second construction element.

30. The connection of claim 28, wherein the bonding material is at a point of contact between the sandwich panel and the surface of the construction element, and the bonding material had a radius that is at least seven times the thickness of the outer layers.

31. The connection of claim 29, wherein the construction element is a second sandwich panel and the surface is a closed edge of the second sandwich panel.

32. The connection of claim 31, wherein the each sandwich panel is comprised of a core having an edge, two outer layers having edges that are separated from one another by the core, and a cavity partially defined by the core and the outer layers, the cavity filled with a bonding material to close the edge of the panel.

33. The connection of claim 28, wherein the bonding material is substantially coplanar to the edges of the outer layers.

34. The connection of claim 28, wherein the closed edge directs a force on the panel to an outer layer of the sandwich panel.
